(19) United States
(12) Patent Application Publication
(10) Pub. No.: US 2002/0131586 A1
(43) Pub. Date: Sep. 19, 2002

(54) Handsfree device for a telephone

(76) Inventor: Hung-Chang Liu, Taipei Hsien (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/804,840

(22) Filed: Mar. 13, 2001

(51) Int. Cl. H04M 1/00; H04M 9/00

(52) U.S. Cl. 379/433.01

(57) ABSTRACT

A handsfree device for a telephone, which has dual-functions of handsfree and mute, has a housing with a recess. Three legs are provided in the housing. A flexible sheet with a convex central portion is received in the recess. A disk is provided on the flexible sheet, and has a plurality of lugs formed at a bottom thereof, and a plurality of teeth formed at a top thereof. A pole is mounted on the disk, and has a plurality of barbs engaged with the teeth respectively. When the pole is pressed to electrify the first and second legs, a handsfree function is actuated, and when the pole is turned to electrify the third leg, a mute function is actuated.

### BACKGROUND OF THE INVENTION

1. Field of the Invention

The present invention is related to a telephone, and more particular to a handsfree device for the telephone.

2. Description of Related Art

Referring to FIGS. 8 and 9, a conventional handsfree device for a telephone comprises a housing (60), a contactor (61) formed at the center of the housing (60), and metal legs (62) formed in the housing and extending downwards. A flexible sheet (70) with a convex central part is received in the housing (60). A pole (80) is provided on the flexible sheet (70) and extends out from a hole (91) in a cover plate (90) mounted on the housing (60).

In a non-actuated state, the flexible sheet (70) is disconnected from the contactor (61). When a user presses the pole (80) down, the flexible sheet (70) is deformed flat and electrically connected with the contactor (61) to switch on the legs (62). Then the handsfree function is actuated. Thus, a user can use the handsfree function by pressing a handsfree-key on a telephone relative to the pole (80).

Furthermore, a telephone usually provides a mute function which is controlled by a mute key on the telephone. Because panels of telephones, especially of mobile phones, are limited, it is too cramped to add the mute keys on the panels. Otherwise, the panels must be enlarged.

Therefore, the invention provides a handsfree device to mitigate and/or obviate the aforementioned problems.

### SUMMARY OF THE INVENTION

The main objective of the invention is to provide a handsfree device for a telephone which integrates a mute function with a handsfree function.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a handsfree device for a telephone in accordance with the invention;

FIG. 2 is a cross sectional view of the combined FIG. 1, showing that a pole of the handsfree device is not pressed and a handsfree function is not actuated;

FIG. 3 is a cross sectional view showing that the pole of the handsfree device is pressed and the handsfree function is actuated;

FIG. 4 is a top view showing that a push bar of the handsfree device is not pushed inwards, and a mute function is not actuated;

FIG. 5 is a cross sectional view taken along line 5-5 in FIG. 4;

FIG. 6 is a top view showing that the push bar of the handsfree device is pushed inwards, and the mute function is actuated;

FIG. 7 is a cross sectional view taken along line 7-7 in FIG. 6;

FIG. 8 is a cross sectional view of a conventional handsfree device; and

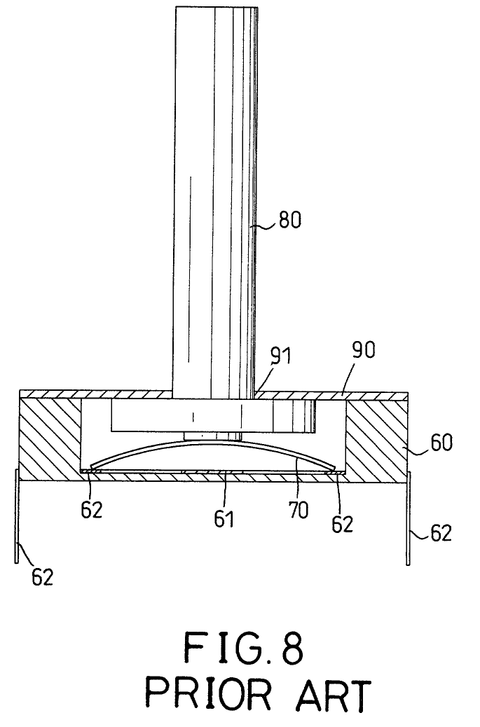

FIG. 9 is a cross sectional view showing that the conventional handsfree device is actuated.

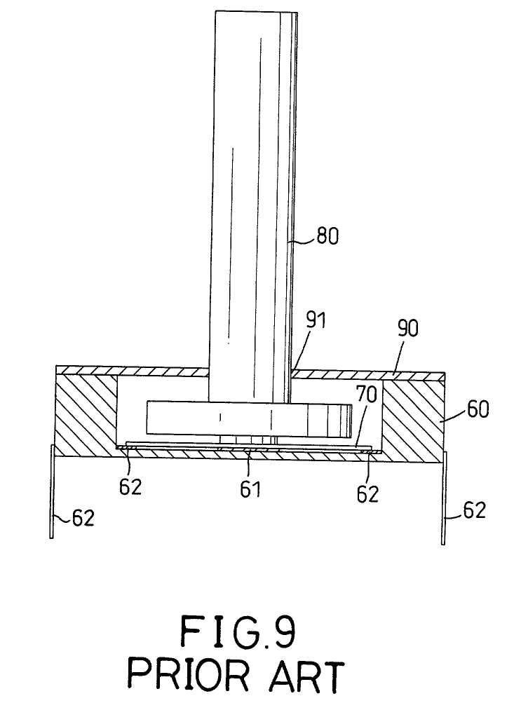

### DETAILED DESCRIPTION OF THE PREFERRED EMBODIMENT

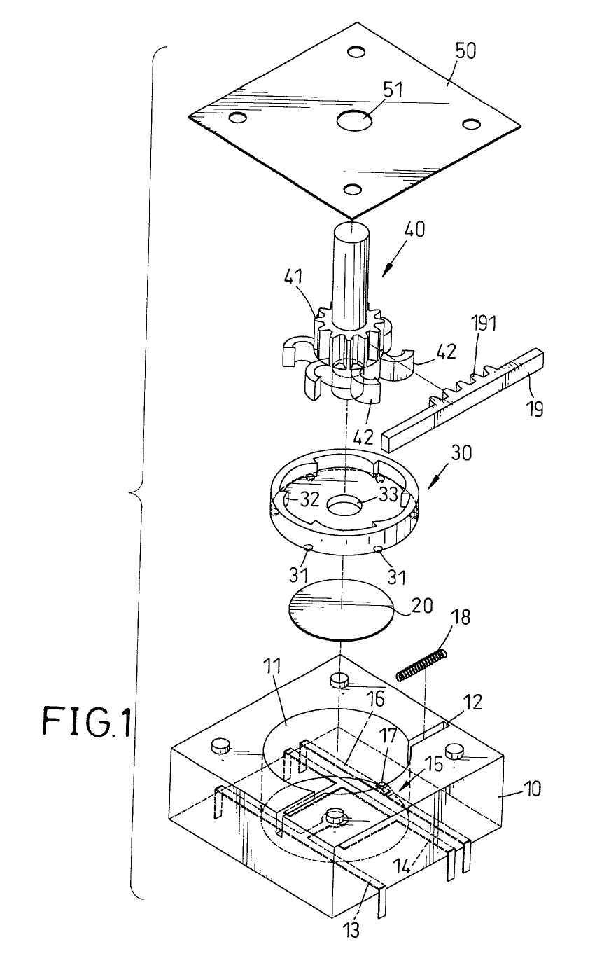

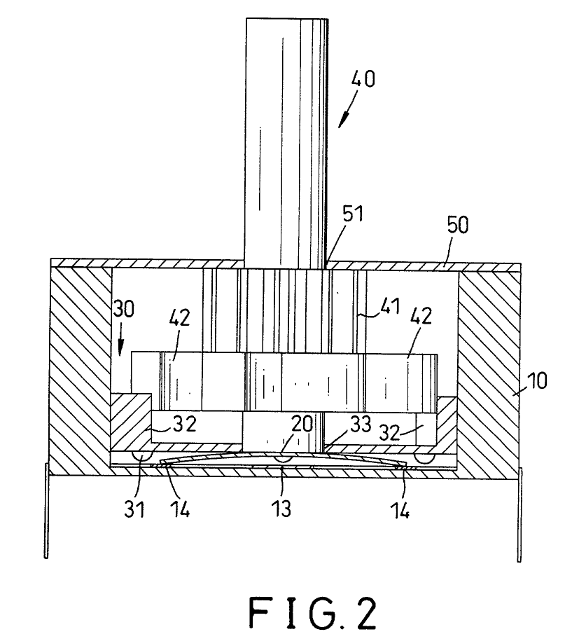

Referring to FIGS. 1 and 2, a handsfree device for a telephone in accordance with the invention has a housing (10) with a circular recess (11) defined therein. A contactor (110) is formed on a bottom face of the recess (11). A channel (12) is laterally defined in an upper surface of the housing (10).

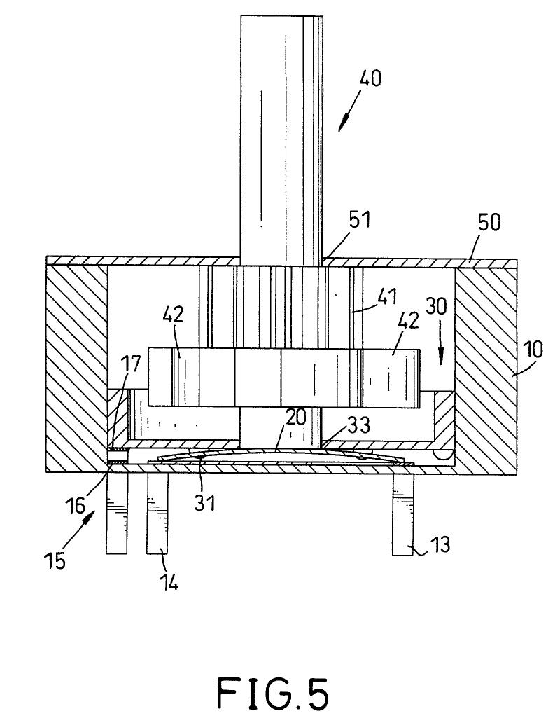

First, second and third metal legs (13, 14, 15) are provided in the housing (10) and laterally extend though the recess (11). Distal ends of the legs (13, 14, 15) are bent downwards to extend out from the housing (10). According to the present invention, the first and second metal legs (13, 14) are designed for a handsfree function, and the third metal leg (15) is designed for a mute function. The legs (13, 14, 15) are separate from each other. The third leg (15) is composed of a first half-leg (16) and a second half-leg (17), and as shown in FIG. 5, a distal end of the second half-leg (17) is bent up to extend over a distal end of the first half-leg (16). In a mute-off state, the distal end of the second half-leg (17) is separate from the distal end of the first half-leg (16).

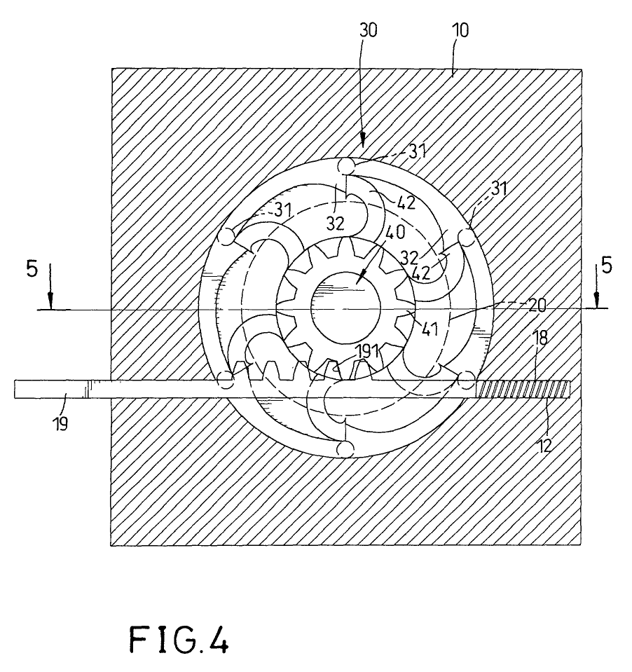

As shown in FIGS. 1 and 4, a spring (18) and a push bar (19) are in turn received in the channel (12), wherein a front end of the push bar (19) abuts the spring (18), and a rear end of the push bar (19) extends out from the channel (12). A rack (191) is formed at a middle portion of the push bar (19).

Referring back FIGS. 1 and 2, a flexible sheet (20) formed with a convex central portion is received in the recess (11). The sheet (20) is electrically connected with the first leg (13) and the second leg (14) but not the third leg (15). In a handsfree-off state, the sheet (20) is not electrically connected with the contactor (110).

A disk (30) is received in the recess (11) and provided on the sheet (20). A plurality of lugs (31) is equally and circumferentially formed on a bottom surface of the disk (30), and a plurality of teeth (32) is equally and circumferentially formed at an upper inner surface of the disk (30). An aperture (33) is defined through a central portion of the disk (30). A diameter of the disk (30) is larger than that of the sheet (20), and the lugs (31) extend beyond an outer periphery of the sheet (20).

A pole (40) is provided on the disk (30) with a lower end thereof extending through the aperture (33) of the disk (30). The pole (40) has a plurality of barbs (42) respectively engaged with the teeth (32), and a gear (41) engaged with the rack (191) of the push bar (19).

A cover plate (50) is provided on a top surface of the housing (10) and has a hole (51) for an upper end of the pole (40) extended therethrough.

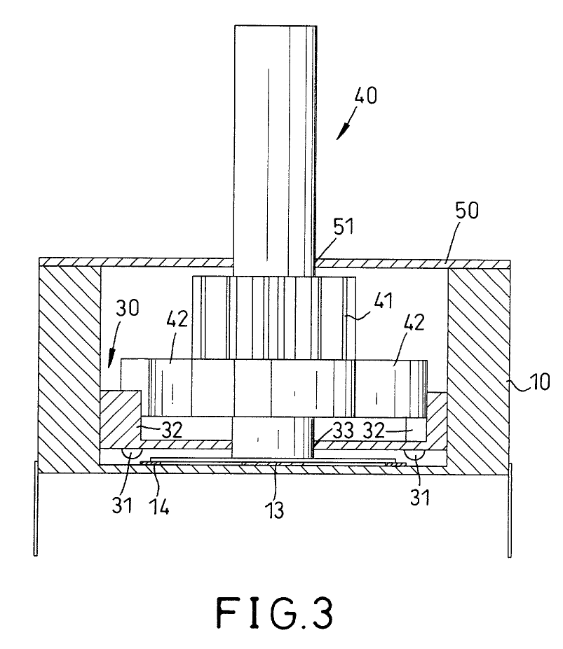

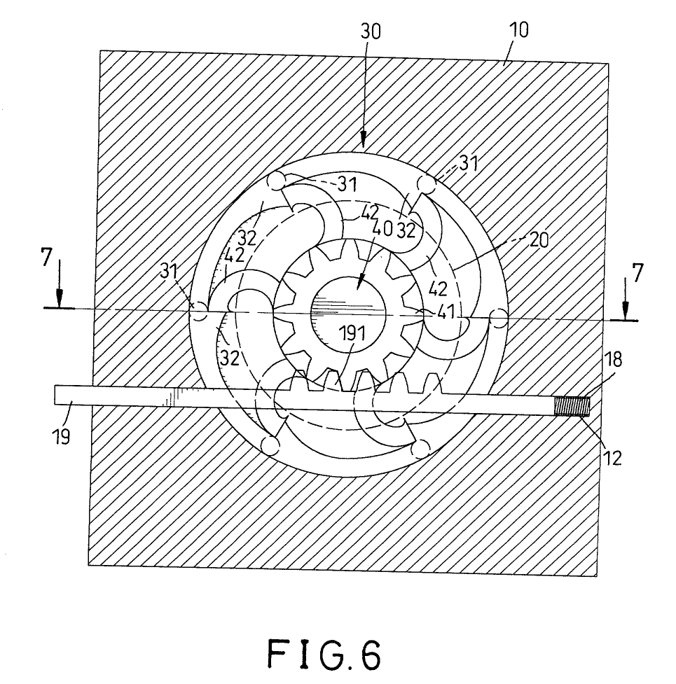

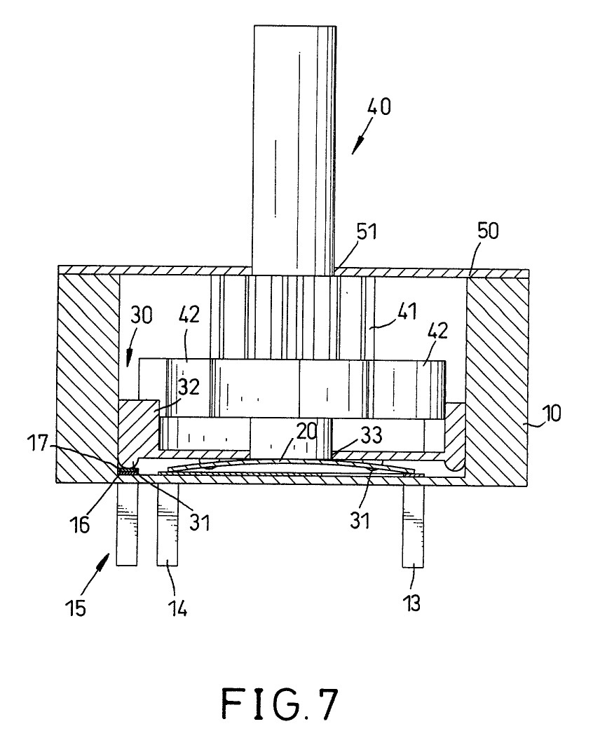

In use, when a user presses the pole (40) downwards, as shown in FIG. 3, the convex central portion of the sheet (20) is deformed flat and is electrically connected with the contactor (110) to electrify the first and second legs (13, 14), then, the handsfree function is actuated. When the user pushes the bar (19) inwards to turn the pole (40) by the engagement between the rack (191) and the gear (41), as shown in FIGS. 6 and 7, the disk (30) rotates and one of the lugs (31) arrives at the distal end of the second half-leg (17) and presses it down to electrically connect the second half-leg (17) with the first half-leg (16), whereby the mute function is actuated.

Alternatively, the handsfree function can be accomplished by turning the pole to electrify the third leg (15), and the mute function can be accomplished by pressing the pole to electrify the first and second legs (13, 14).

From the above description, it is noted that the invention has the following advantages:

1. By providing dual-function key, the structure of a telephone is compact.

2. It is also convenient for a user to utilize the two functions by using only one hand.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fall extent indicated by the broad general meaning of the terms in which the appended claims are expressed.

What is claimed is:

1. A handsfree device for a telephone, comprising:
a housing (10) having a recess (11) defined therein, and a contactor (110) formed in a bottom face of the recess (11);
three metal legs (13, 14, 15) respectively provided in the housing (10), laterally extending through the recess (11) and separate from each other, wherein the first leg (13) and the second leg (14) are designed for a first function, and the third leg (15) is designed for a second function and composed of a first half-leg (16) and a second half-leg (17) separate from each other, wherein a distal end of the second half-leg (17) is bent up and extends over a distal end of the first half-leg (16);
a flexible sheet (20) received in the recess (11), the sheet (20) having a convex central portion, and respectively electrically connected with the first leg (13) and the second leg (14);
a disk (30) received in the recess (11) and mounted on the flexible sheet (20), the disk (30) having a plurality of lugs (31) equally and circumferentially formed on a bottom surface thereof, a plurality of teeth (32) equally and circumferentially formed at an upper surface thereof, and an aperture (33) defined therethrough;
a pole (40) provided on the disk (30) with a lower end thereof inserting through the aperture (33), the pole (40) having a plurality of barbs (42) formed on a periphery thereof and respectively engaged with the teeth (32) of the disk (30); and
a cover plate (50) provided on the housing (10), and having a hole (51) defined therethrough for an upper end of the pole (40) extending out therefrom,
whereby, pressing the pole (40) down deforms the flexible sheet (20) to electrically connect the first and second legs (13, 14) with the contactor (110) to actuate the first function, and turning the pole (40) can move one of the lugs (31) to the distal end of the second half-leg (17), by which the second half-leg (17) is pressed downwards to be electrically connected with the first half-leg (16) to actuate the second function.

2. The handsfree device for a telephone as claimed in claim 1, wherein
the housing (10) further has a channel (12) laterally defined in the upper surface thereof; and a push bar (19) received in the channel (12) and having a rack (191) formed thereon; and
the pole (40) further has a gear (41) formed thereon and engaged with the rack (191) of the push bar (19).

3. The handsfree device for a telephone as claimed in claim 2, wherein the housing (10) further has a spring (18) received in the channel (12) and the spring (18) abuts the push bar (19).

4. The handsfree device for a telephone as claimed in claim 1, wherein a diameter of the disk (30) is larger than a diameter of the flexible sheet (20).
